(19) United States
(12) Patent Application Publication
(10) Pub. No.: US 2025/0159109 A1
(43) Pub. Date: May 15, 2025

(54) INFORMATION PROCESSING SYSTEM AND NON-TRANSITORY COMPUTER-READABLE RECORDING MEDIUM

(71) Applicant: FUJIFILM Business Innovation Corp., Tokyo (JP)

(72) Inventors: Nanaka IKEDA, Kanagawa (JP); Shinichi MAEKAWA, Kanagawa (JP); Ko TAKEUCHI, Kanagawa (JP); Masami SUDO, Kanagawa (JP); Hiroshi NIMIYA, Kanagawa (JP); Hirotake SASAKI, Kanagawa (JP); Arisa YOSHIDA, Kanagawa (JP); Yukiko USAMI, Kanagawa (JP)

(73) Assignee: FUJIFILM Business Innovation Corp., Tokyo (JP)

(21) Appl. No.: 18/648,480

(22) Filed: Apr. 29, 2024

(30) Foreign Application Priority Data
Nov. 15, 2023 (JP) 2023-194489

(51) Int. Cl. H04N 7/15; G10L 25/78

(52) U.S. Cl. CPC H04N 7/152; G10L 25/78

(57) ABSTRACT

An information processing system includes a processor, wherein the processor acquires status information that is information related to a status of a nearby person who is a person located around a subject, and when the status specified by the status information acquired is a particular status, the processor generates control information that is used for controlling a device owned by the subject and causes the device to issue a notification indicating that there is a possibility of utterance by the nearby person.

### CROSS-REFERENCE TO RELATED APPLICATIONS

This application is based on and claims priority under 35 USC 119 from Japanese Patent Application No. 2023-194489 filed Nov. 15, 2023.

### BACKGROUND

### (i) Technical Field

The present invention relates to an information processing system and a non-transitory computer-readable recording medium.

### (ii) Related Art

JP2006-338493A discloses processing in which, when there is a user who has gained the sight of a majority of users among users except for a user who is directing the sight to a current utterer in a conversation, this user is determined to be a next utterer.

JP2012-146072A discloses an apparatus including notification voice storage means that stores, for each meeting participant, a notification voice for notifying the meeting participants of a next utterer.

JP2023-112602A discloses a configuration including chat text input means that receives an input of chat text and voice synthesis means that performs voice synthesis of the chat text into chat voice data.

### SUMMARY

In a case where an utterer intends to communicate with a third party other than the utterer, the utterer usually utters his or her own utterance, avoiding a timing in which the third party is uttering.

When the utterer utters while a third party is uttering, the utterance by the third party is disturbed or the utterance by the utterer is less likely to be recognized by the third party. Aspects of non-limiting embodiments of the present disclosure relate to an information processing system that specifies a timing of an utterance that an utterer is about to make more easily than a configuration in which a notification related to an utterance is not issued to the utterer.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising a processor, wherein the processor acquires status information that is information related to a status of a nearby person who is a person located around a subject, and when the status specified by the status information acquired is a particular status, the processor generates control information that is used for controlling a device owned by the subject and causes the device to issue a notification indicating that there is a possibility of utterance by the nearby person.

### BRIEF DESCRIPTION OF THE DRAWINGS

Exemplary embodiments of the present invention will be described in detail based on the following figures, wherein:

FIG. 1 is a diagram illustrating an overall configuration of an information processing system;

FIG. 2 is a diagram illustrating a configuration of a management server;

FIG. 3 is a diagram illustrating a hardware configuration of a device;

FIGS. 4A to 4D are diagrams illustrating processing executed in the information processing system;

FIG. 5 is a diagram illustrating a database stored in an information storage of the management server;

FIG. 6 is a diagram illustrating another display example on a display unit of the device;

FIGS. 7A to 7C are diagrams illustrating another processing example;

FIGS. 8A to 8C are diagrams illustrating another processing example;

FIGS. 9A to 9C are diagrams illustrating another processing example;

FIG. 10 is a diagram illustrating another processing example;

FIG. 11 is a diagram of a case where the display unit and nearby persons are viewed from a direction indicated by an arrow XI in FIG. 10;

FIG. 12 is a flowchart illustrating a flow of processing executed when notification processing is performed;

FIGS. 13A to 13D are diagrams illustrating specific examples of processing;

FIG. 14 is a diagram illustrating a series of flows of display processing; and

FIG. 15 is a flowchart illustrating a flow of processing in a case where notification processing is also performed at an end of utterance.

### DETAILED DESCRIPTION

In the following, exemplary embodiments of the present invention will be described with reference to the accompanying drawings.

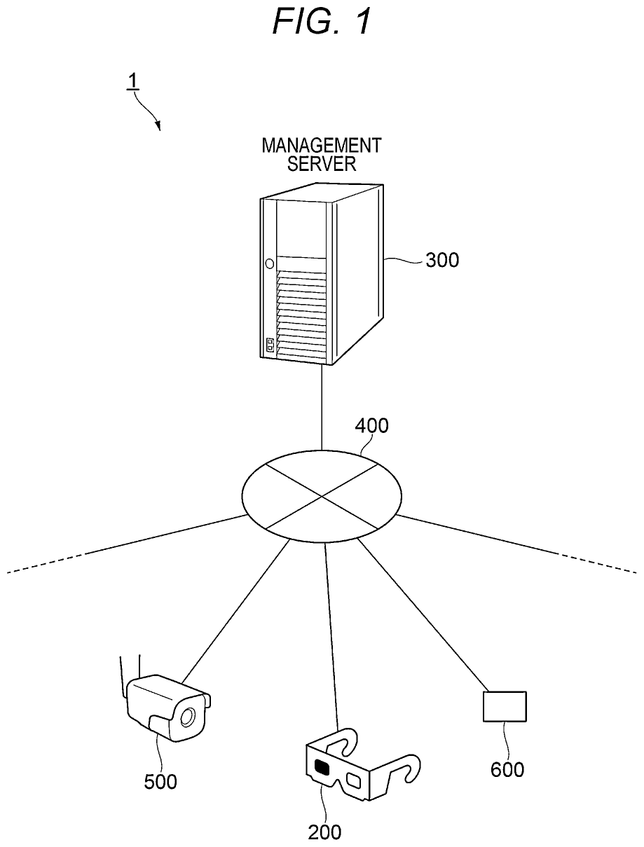

FIG. 1 is a diagram illustrating an overall configuration of an information processing system 1 according to the present exemplary embodiment.

The information processing system 1 is provided with a management server 300 as an example of an information processing apparatus. In addition, the information processing system 1 is provided with a device 200 to be worn by each subject to be described later.

Although only one device 200 is illustrated in FIG. 1, a plurality of devices 200 is provided in accordance with the number of subjects. The device 200 is an eyeglass device 200 and is worn on the head of a subject. The subject visually recognizes the surroundings of the subject by the device 200.

Furthermore, in the present exemplary embodiment, an overall camera 500 is provided as a camera that images the subject wearing the device 200 and nearby persons (described later) located around the subject.

The overall camera 500 is provided for each location of the subject, and when there is a plurality of subjects, a plurality of overall cameras 500 is also provided.

Furthermore, in the present exemplary embodiment, an individual microphone 600 worn by each nearby person to be described later is provided. The individual microphone 600 acquires voice of a nearby person and generates voice information.

The individual microphone 600 is provided for each nearby person, and when there is a plurality of nearby persons, a plurality of individual microphones 600 is provided.

Each of the device 200, the overall camera 500, and the individual microphone 600 is connected to the management server 300 through a communication line 400 such as the Internet.

### [Configuration of Management Server]

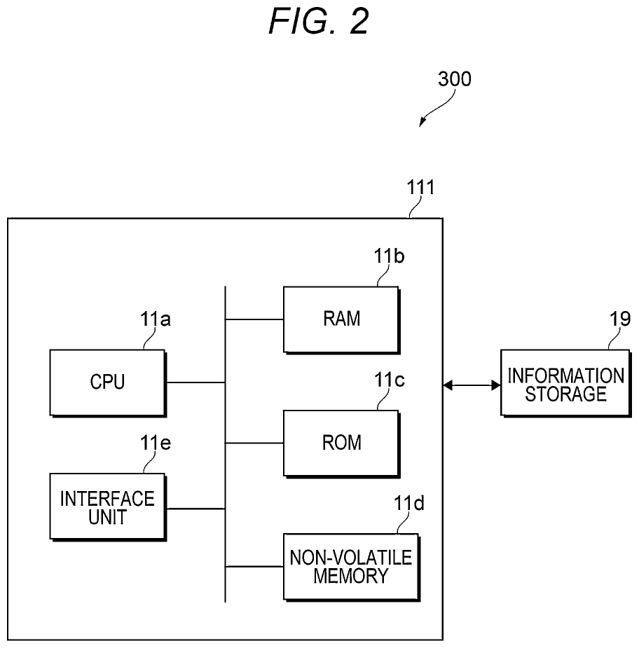

FIG. 2 is a diagram illustrating a configuration of the management server 300. The management server 300 is implemented by a computer.

The management server 300 includes a calculation processor 111 that executes digital calculation processing in accordance with a program, and an information storage 19 that stores information.

The information storage 19 is implemented by, for example, an existing information storage device such as a hard disk drive (HDD), a semiconductor memory, or a magnetic tape. The calculation processor 111 is provided with a CPU 11a as an example of a processor.

The calculation processor 111 is provided with a RAM 11b used as a working memory or the like of the CPU 11a and a ROM 11c in which a program or the like to be executed by the CPU 11a is stored.

The calculation processor 111 is provided with a non-volatile memory 11d that is configured to be rewritable and can hold data even when power supply is stopped, and an interface unit 11e that controls each unit such as a communication unit connected to the calculation processor 111.

The non-volatile memory 11d includes, for example, a battery-backed SRAM, a flash memory, or the like. The information storage 19 stores various types of information such as a program to be executed by the calculation processor 111.

In the present exemplary embodiment, the CPU 11a provided in the calculation processor 111 reads a program stored in the ROM 11c or the information storage 19, and thus various types of processing performed in the management server 300 are executed.

The program to be executed by the CPU 11a can be provided to the management server 300 in a state of being stored in a computer-readable recording medium such as magnetic recording medium (a magnetic tape, a magnetic disk, or the like), an optical recording medium (optical discs and the like), a magneto-optical recording medium, or a semiconductor memory. The program to be executed by the CPU 11a may be provided to the management server 300 by using a communication means such as the Internet.

### [Configuration of Device]

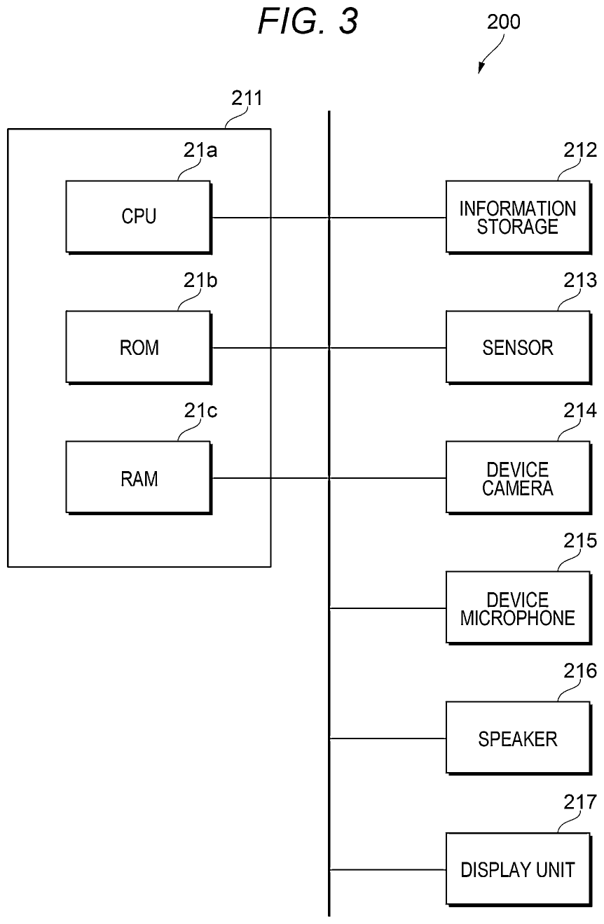

FIG. 3 is a diagram illustrating a hardware configuration of the device 200.

The device 200 includes a calculation processor 211, an information storage 212, a sensor 213, a device camera 214, a device microphone 215, a speaker 216, and a display unit 217.

The calculation processor 211 is provided with a CPU 21a as an example of a processor. In addition, the calculation processor 211 is provided with a RAM 21c used as a working memory or the like of the CPU 21a and a ROM 21b in which a program or the like to be executed by the CPU 21a is stored.

The information storage 212 is implemented by an existing information storage device such as a semiconductor memory.

Examples of the sensor 213 include a GPS sensor and a direction sensor. With reference to an output from the sensor 213, the current position of the device 200 and the orientation of the device 200 can be specified.

The device camera 214 is a camera that images the surroundings of the device 200.

The device camera 214 faces a front direction of the subject and captures an image in the front direction in a state where the device 200 is worn by the subject. In other words, the device camera 214 is directed to a direction in which the subject is directed, and captures an image of a forward direction of the subject.

The device microphone 215 acquires voice of the subject and generates voice information.

The speaker 216 outputs sound and voice, and performs notification processing for the subject wearing the device 200.

The display unit 217 is a so-called display and displays various types of information. The display unit 217 is placed in front of the subject in a state where the device 200 is worn by the subject.

In the present exemplary embodiment, a video acquired by the device camera 214 is displayed on the display unit 217. In a state where the device 200 is worn by the subject, a video in which a state in front of the subject is displayed on the display unit 217.

In the present exemplary embodiment, the subject visually recognizes the front of the subject by referring to the video displayed on the display unit 217.

In addition, there is also a transmissive device 200, and in this case, as the display unit 217, a transparent display unit 217 is installed so that the subject can visually recognize the back of the display unit 217.

The subject visually recognizes the back of the display unit 217 by the display unit 217. In other words, the subject visually recognizes the front of the subject by the display unit 217.

When an image is displayed on the display unit 217 in the transmissive device 200, the user visually recognizes both a real space located behind the display unit 217 and the image displayed on the display unit 217.

The program executed by the CPU 21a can be provided to the device 200 in a state of being stored in a computer-readable recording medium such as magnetic recording medium (a magnetic tape, a magnetic disk, or the like), an optical recording medium (optical discs and the like), a magneto-optical recording medium, or a semiconductor memory. The program to be executed by the CPU 21a may be provided to the device 200 by using a communication means such as the Internet.

Note that the device 200 is not limited to the eyeglass device 200, and may be, for example, a smartphone, a tablet terminal, or the like. The eyeglass device 200, the smartphone, the tablet terminal, and the like are all devices that the subject can carry.

The smartphone and the tablet terminal are also provided with a display unit and a device camera. The subject can visually recognize the front of the subject by referring to a video captured by the device camera and displayed on the display unit.

In other words, in this case, the subject can visually recognize a space located in front of the subject and behind the smartphone or the tablet terminal by referring to the display unit provided in the smartphone or the tablet terminal placed in front of the subject.

In the present exemplary embodiment, notification processing to be described later is performed through the device 200. However, the notification processing can be performed not only with use of the eyeglasses device 200 but also with use of a smartphone or a tablet terminal.

In the specification, the processor refers to a processor in a broad sense, and includes general-purpose processors (for example, a central processing unit (CPU) and the like) and dedicated processors (for example, a graphics processing unit (GPU), an application specific integrated circuit (ASIC), a field programmable gate array (FPGA), a programmable logic device, and the like).

The operation of the processor may be performed not only by one processor but also by a plurality of processors existing at physically distant positions in cooperation with each other. The order of the operations of the processor is not limited to only the order described in the present exemplary embodiment and may be changed.

### [Description of Processing Executed in Information Processing System]

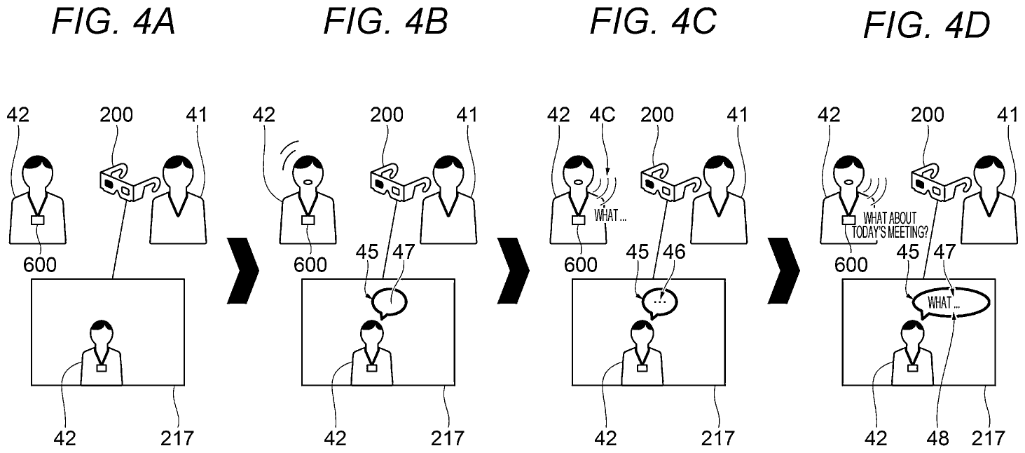

FIGS. 4A to 4D are diagrams illustrating processing executed in the information processing system 1 according to the present exemplary embodiment.

FIG. 4A illustrates a subject 41 for whom notification processing is performed and a nearby person 42 who is a person located around the subject 41.

In the present exemplary embodiment, as illustrated in FIG. 4A, the device 200 is worn by the subject 41 for whom the notification processing is performed. In the present exemplary embodiment, as illustrated in FIG. 4A, the nearby person 42 is displayed on the display unit 217 provided in the device 200.

Furthermore, in the present exemplary embodiment, as illustrated in FIG. 4A, the individual microphone 600 is worn by the nearby person 42.

As described above, the device 200 according to the present exemplary embodiment is an eyeglass device. The eyeglass device 200 is worn on the head of the subject 41. The subject 41 visually recognizes the nearby person 42 located around the subject 41 by the device 200. In other words, the subject 41 visually recognizes the nearby person 42 located in front of the subject 41 by the device 200.

As described above, the device 200 is provided with the device camera 214 (see FIG. 3) and the display unit 217 capable of displaying a video acquired by the device camera 214.

The subject 41 visually recognizes the nearby person 42 by referring to the nearby person 42 imaged by the device camera 214 and displayed on the display unit 217.

Note that when the device 200 is the transmissive device described above, the subject 41 visually recognizes, by the transparent display unit 217, the nearby person 42 located behind the display unit 217.

In the present exemplary embodiment, in the state illustrated in FIG. 4A, a CPU 11a as an example of a processor provided in the management server 300 (see FIG. 2) acquires status information that is information related to a status of the nearby person 42 as a person located around the subject 41.

Specifically, the CPU 11a acquires the status information on the nearby person 42 based on a video in which the nearby person 42 appears and voice information that is information related to the voice of the nearby person 42.

When the status information of the nearby person 42 is acquired based on a video in which the nearby person 42 appears, the CPU 11a acquires the status information of the nearby person 42 based on the video acquired by the device camera 214 (see FIG. 3) provided in the device 200.

In the present exemplary embodiment, the video acquired by the device camera 214 is transmitted to the management server 300 via the communication line 400 (see FIG. 1).

The CPU 11a of the management server 300 analyzes the video and acquires the status information of the nearby person 42. The CPU 11a acquires the status information of the nearby person 42 based on the video in which the nearby person 42 appears.

When the status information of the nearby person 42 is acquired based on the voice information of the nearby person 42, the CPU 11a acquires the status information of the nearby person 42 based on the voice information acquired by the individual microphone 600 that is a microphone worn by each nearby person 42.

In the present exemplary embodiment, the voice information acquired by the individual microphone 600 is transmitted to the management server 300 through the communication line 400. The CPU 11a of the management server 300 analyzes the voice information and acquires the status information of the nearby person 42.

### [Description of Database]

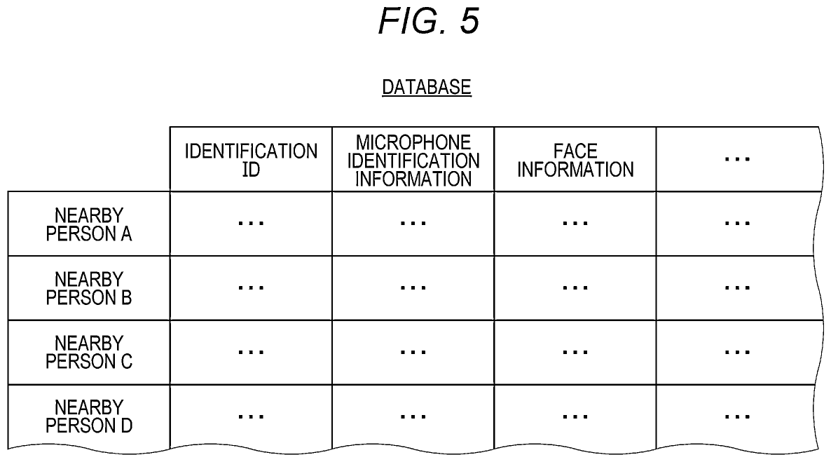

FIG. 5 is a diagram illustrating a database stored in the information storage 19 (see FIG. 2) of the management server 300.

In the present exemplary embodiment, as illustrated in FIG. 5, information related to the nearby person 42 is registered for each nearby person 42 in the database stored in the information storage 19.

In the present exemplary embodiment, an identification ID that is information used for identifying each nearby person 42, microphone identification information that is identification information of the individual microphone 600 of each nearby person 42, face information of the nearby person 42, and the like are registered for each of the nearby persons 42 in advance in the database.

In the present exemplary embodiment, an image of the face of the nearby person 42 is captured in advance. Then, the face information that is information on the face of the nearby person 42 is registered in the database.

As the face information, an image of the face of the nearby person 42 and information related to a feature amount of the face of the nearby person 42 obtained by analyzing the image are registered.

In the present exemplary embodiment, as described above, the video acquired by the device camera 214 and the voice information acquired by the individual microphone 600 are transmitted to the management server 300.

The CPU 11a of the management server 300 acquires the video and the voice information, and acquires the status information of the nearby person 42 based on the video and the voice information.

Specifically, when the CPU 11a of the management server 300 acquires the video acquired by the device camera 214, the CPU 11a specifies the nearby person 42 appearing in the video based on the image of the face of the nearby person 42 appearing in the video and the face information stored in the database.

Furthermore, the CPU 11a of the management server 300 analyzes the video and acquires the status information of the specified nearby person 42.

When acquiring the voice information acquired by the individual microphone 600, the CPU 11a of the management server 300 specifies the nearby person 42 whose voice information by the individual microphone 600 has been acquired, based on the microphone identification information transmitted to the management server 300 together with the voice information and the microphone identification information stored in advance in the database.

Furthermore, the CPU 11a of the management server 300 analyzes the voice information and acquires the status information on the specified nearby person 42.

Each individual microphone 600 stores the microphone identification information for identifying each individual microphone 600.

The voice information acquired by the individual microphone 600 and the microphone identification information are transmitted from the individual microphone 600 to the management server 300.

The CPU 11a of the management server 300 specifies the nearby person 42 whose voice information has been acquired by the individual microphone 600, based on the microphone identification information and the microphone identification information registered in the database.

In the present exemplary embodiment, the individual microphone 600 (see FIG. 4A) is prepared for each nearby person 42.

In the present exemplary embodiment, the voice information of each nearby person 42 is acquired by the individual microphone 600 prepared for each nearby person 42.

In the present exemplary embodiment, the voice information obtained by the individual microphone 600 is transmitted to the management server 300 together with the microphone identification information as described above.

The CPU 11a of the management server 300 specifies the nearby person 42 based on the microphone identification information, and furthermore, acquires status information based on the voice information for the specified nearby person 42.

Specifically, in the present exemplary embodiment, for the transmission of the voice information from the individual microphone 600 to the management server 300, voice information whose sound pressure exceeds a predetermined threshold is selected by the individual microphone 600 from among the voice information acquired by the individual microphone 600.

Next, the selected voice information is transmitted to the management server 300 from the individual microphone 600 together with the microphone identification information.

Thus, in the present exemplary embodiment, transmission of the voice information of another nearby person 42 different from the nearby person 42 wearing the individual microphone 600 to the management server 300 through the individual microphone 600 is suppressed.

Another nearby person 42 is far from the microphone-wearing nearby person 42 who is the nearby person 42 wearing the individual microphone 600, and usually, the sound pressure of the voice of the other nearby person 42 acquired by the individual microphone 600 becomes small.

In a configuration in which the voice information whose sound pressure exceeds the predetermined threshold is selected and the voice information is transmitted to the management server 300, the voice information of another nearby person 42 is suppressed from being transmitted to the management server 300 through the individual microphone 600 of the microphone-wearing nearby person 42.

Note that the management server 300 may select the voice information whose sound pressure exceeds the predetermined threshold.

In this case, the management server 300 selects voice information whose sound pressure exceeds the predetermined threshold from the voice information transmitted from the individual microphone 600.

Then, the management server 300 acquires the selected voice information as the voice information of the microphone-wearing nearby person 42.

In addition, the CPU 11a of the management server 300 may acquire voice information of each nearby person 42 based on voice information obtained by a microphone provided in a terminal device of each nearby person 42, such as a smartphone or a tablet terminal of each nearby person 42.

In addition, a common microphone may be provided, and the CPU 11a of the management server 300 may acquire the voice information of each nearby person 42 based on the voice information acquired by the common microphone.

In a case of using a common microphone, feature information that is information related to a feature of the voice of each nearby person 42 is registered in advance in the database.

The CPU 11a of the management server 300 specifies the voice information of each nearby person 42 based on the feature information registered in the database, and acquires the status information of each nearby person 42 based on the voice information.

### [Description of Specific Processing]

In the present exemplary embodiment, as described above, the CPU 11a of the management server 300 acquires the status information of the nearby person 42 based on the video acquired by the device camera 214 or the voice information acquired by the individual microphones 600.

Next, when the status specified by the acquired status information is a particular status, the CPU 11a generates control information to be used for controlling the device 200 owned by the subject 41 (see FIG. 4A).

Specifically, the CPU 11a generates, as the control information, control information that causes a predetermined notification to be issued to the subject 41 through the device 200.

More specifically, the CPU 11a generates control information that causes a notification to be issued to the subject 41 when the status specified by the acquired status information is a status in which there is a possibility of utterance by the nearby person 42.

More specifically, the CPU 11a generates control information that causes the device 200 to issue a notification indicating that there is a possibility of utterance by the nearby person 42.

When the status specified by the acquired status information is, for example, any of the following statuses, the CPU 11a determines that there is a possibility of an utterance by the nearby person 42.
When there is a breath sound of the nearby person 42
When the nearby person 42 utters a specific voice such as “Mmm”, “Well”, “Ah”, and “Eh”
When the expression of the nearby person 42 becomes a particular expression such as an increase in the degree of opening of the mouth of the nearby person 42
When the nearby person 42 has looked in a direction in which the subject 41 exists for more than a predetermined time period
When the nearby person 42 has turned to the direction in which the subject 41 exists
When the nearby person 42 performs a predetermined specific action such as nodding the nearby person 42 moving the hand of the nearby person 42 close to the face or stretching the posture of the nearby person 42

In addition, the status information on the nearby person 42 may be acquired based on biological information of the nearby person 42.

Specifically, the CPU 11a may acquire the status information on the nearby person 42 based on biological information such as a pulse, a heart rate, and a blood pressure obtained by a sensor (not illustrated) worn by the nearby person 42.

When the status information of the nearby person 42 is acquired based on the biological information, the biological information obtained by the sensor and sensor identification information for each sensor are transmitted from the sensor to the management server 300 through a communication line (not illustrated).

The CPU 11a of the management server 300 specifies the nearby person 42 based on the sensor identification information, and determines that there is a possibility of utterance by the specified nearby person 42 when the status specified by the transmitted biological information is a particular status.

Specifically, for example, when a numerical value of a pulse, a heart rate, a blood pressure, or the like has increased, the CPU 11a of the management server 300 determines that there is a possibility of utterance by the nearby person 42 specified based on the sensor identification information.

In a processing example illustrated in FIGS. 4A to 4D, the CPU 11a generates control information that causes a display image indicating that there is a possibility of utterance by the nearby person 42 to be displayed on the display unit 217 of the device 200 as control information that causes the device 200 to issue a notification indicating that there is a possibility of utterance by the nearby person 42 (see FIG. 4A).

The generated control information is transmitted to the device 200, and the device 200 performs display control of the display unit 217 based on the control information.

Thus, in the present exemplary embodiment, as illustrated in FIG. 4B, a display image 45 indicating that there is a possibility of utterance by the nearby person 42 is displayed on the display unit 217 of the device 200.

The display image 45 is an image representing a so-called “balloon”.

In the present exemplary embodiment, when it is determined that there is a possibility of utterance by the nearby person 42, the display image 45 including an image representing a balloon is displayed on the display unit 217 of the device 200 as illustrated in FIG. 4B before utterance content to be described later is displayed.

Thus, the subject 41 recognizes that there is a possibility of utterance by the nearby person 42.

The display image 45 is not limited to a two-dimension (2D) image but may be a three-dimension (3D) image. When the display image 45 is a three-dimension (3D) image, images with different angles for each eye are displayed on the display unit 217. In other words, when the display image 45 is a three-dimension (3D) image, a plurality of images having different viewing angles is displayed on the display unit 217 as the display image 45.

Note that the control information may be generated by a device other than the management server 300.

In the present exemplary embodiment, the management server 300 generates the control information, but not necessarily, and the control information may be generated by an apparatus other than the management server 300.

The control information may be generated by, for example, the device 200.

When the device 200 generates the control information, the device 200 determines whether the nearby person 42 is in a particular status, for example, based on a video of the nearby person 42 obtained by the device camera 214 (see FIG. 3) included in the device 200 or voice information obtained by the individual microphone 600.

Then, when the nearby person 42 is in a particular status, the device 200 generates control information that causes the device 200 to issue a notification indicating that there is a possibility of utterance by the nearby person 42.

Specifically, the device 200 generates control information that causes the display image 45 to be displayed on the display unit 217 of the device 300.

Thus, as in the case where the CPU 11a of the management server 300 generates the control information, the display image 45 is displayed on the display unit 217 of the device 200.

The CPU 11a of the management server 300 generates, as the control information that causes the display image 45 (see FIG. 4B) to be displayed on the display unit 217, control information that causes the display image 45 to be displayed in such a manner that the display image 45 is associated with the nearby person 42 appearing in the display unit 217.

Accordingly, as illustrated in FIG. 4B, the display image 45 is displayed in such a manner that the display image 45 is associated with the nearby person 42 appearing on the display unit 217.

Specifically, in the present exemplary embodiment, the display image 45 is displayed in such a manner that the display image 45 is associated with a periphery of the head of the nearby person 42.

The CPU 11a of the management server 300 specifies each nearby person 42 appearing on the display unit 217 based on the video acquired by the device camera 214 (see FIG. 3).

Specifically, the CPU 11a of the management server 300 specifies each nearby person 42 appearing on the display unit 217 of the device 200 based on the video of the nearby person 42 appearing in the video acquired by the device camera 214 and the face information registered in the database.

Then, the CPU 11a of the management server 300 generates control information for associating the display image 45 with the nearby person 42 determined to have a possibility of utterance (hereinafter, referred to as “utterance possibility nearby person 42” in some cases) among the specified nearby persons 42.

Specifically, when generating the control information, the CPU 11a generates control information including position information that is information related to a display position of the display image 45.

The CPU 11a determines, as the display position of the display image 45, the position of the utterance possibility nearby person 42 appearing in the video acquired by the device camera 214, and generates control information including position information that is information related to the display position.

Specifically, the CPU 11a determines, as the display position of the display image 45, a position around the head of the utterance possibility nearby person 42 on the video acquired by the device camera 214.

Then, the CPU 11a generates control information including the position information that is information of the determined display position.

Then, in the present exemplary embodiment, control information including the position information is transmitted to the device 200.

Next, the device 200 performs display control so that the display image 45 is displayed at the position specified by the position information.

Thus, as illustrated in FIG. 4B, the display image 45 is displayed on the display unit 217 of the device 200 in such a manner that the display image 45 is associated with the utterance possibility nearby person 42 who has a possibility of utterance.

When the device 200 is the transmissive device 200, the CPU 11a of the management server 300 generates control information that causes the display image 45 to be displayed at a portion of the display unit 217 of the device 200 which is located on a straight line connecting an eye of the subject 41 and the utterance possibility nearby person 42.

In this case, the CPU 11a of the management server 300 first acquires an angle formed by the forward direction of the device 200 and a direction from the device 200 toward the utterance possibility nearby person 42.

Specifically, the CPU 11a of the management server 300 analyzes the video acquired by the device camera 214, and acquires the angle formed by the forward direction and the direction toward the utterance possibility nearby person 42.

Then, the CPU 11a determines the display position of the display image 45 on the display unit 217 based on the formed angle, and generates control information including information related to the determined display position.

Thus, in the transmissive device 200, the display image 45 is also displayed in such a manner that the display image 45 is associated with the utterance possibility nearby person 42 who has a possibility of utterance.

In this case, the subject 41 visually recognizes the utterance possibility nearby person 42 existing in the real space and the display image 45 appearing on the display unit 217 and is located between the eyes of the subject 41 and the utterance possible nearby person 42.

Thereafter, in this processing example, as illustrated by the reference numeral 4C in FIG. 4C, actual utterance by the nearby person 42 is started. In other words, actual utterance by the utterance possibility nearby person 42 is started.

When actual utterance by the nearby person 42 is started, as illustrated in FIG. 4C, an image 46 indicating that utterance by the nearby person 42 has been started is displayed inside of the display image 45 displayed in association with the nearby person 42.

When there is actual utterance by the nearby person 42 with which the display image 45 is associated, the image 46 indicating that the utterance by the nearby person 42 has been started is displayed inside of the display image 45.

In other words, in the present exemplary embodiment, when there is actual utterance by the nearby person 42 with which the display image 45 is associated, an image indicating that the acquisition of voice information by the individual microphones 600 has been started is displayed inside of the display image 45.

Whether there has been actual utterance by the nearby person 42 with which the display image 45 is associated is determined, for example, based on an output from the individual microphone 600 worn by the nearby person 42.

In the present exemplary embodiment, the image 46 indicating that utterance by the nearby person 42 has been started is displayed in a region surrounded by the display image 45.

The image 46 indicating the start is displayed on the display unit 217 of the device 200 until the utterance content of the nearby person 42 is acquired by the CPU 11a of the management server 300.

It takes time for the CPU 11a to acquire the utterance content. In the present exemplary embodiment, until the utterance content is acquired by CPU 11a, the image 46 indicating that an utterance by the nearby person 42 has been started is displayed on the display unit 217.

The display of the image 46 indicating that the processing has been started is not necessary, and the display illustrated in FIG. 4D, which will be described next, may be performed after the display illustrated in FIG. 4B without performing the display illustrated in FIG. 4C. When there is actual utterance by the nearby person 42, the CPU 11a of the management server 300 acquires utterance content which is the content of the utterance by the nearby person 42.

The CPU 11a of the management server 300 analyzes the voice information transmitted from the individual microphone 600 worn by the nearby person 42 with which the display image 45 is associated, and acquires the utterance content of the nearby person 42. Note that the utterance content is only required to be acquired based on the voice information by using a known method.

Next, the CPU 11a of the management server 300 generates control information that causes the acquired utterance content to be displayed on the display unit 217 in association with the nearby person 42 who has uttered with the utterance content.

Then, the CPU 11a of the management server 300 transmits the generated control information to the device 200.

Thus, in the present exemplary embodiment, as illustrated in FIG. 4D, utterance content 48 of the nearby person 42 is displayed at a predetermined display section 47 on the display unit 217 of the device 200.

In the present exemplary embodiment, when the nearby person 42 who has a possibility of utterance actually utters, the utterance content 48 of the nearby person 42 is displayed on the display unit 217 of the device 200.

In the present exemplary embodiment, when the utterance content 48 is displayed, the utterance content 48 is displayed inside of the display image 45 including an image representing a balloon.

In the present exemplary embodiment, the utterance content 48 of the nearby person 42 is displayed inside of the display image 45 displayed in association with the nearby person 42 determined to have a possibility of utterance.

In the processing example described above, the CPU 11a first generates control information that causes the display image 45 to be displayed on the display unit 217 of the device 200 as described above when there is a possibility of utterance by the nearby person 42.

Thus, as illustrated in FIG. 4B, the display image 45 is displayed on the display unit 217.

The CPU 11a generates, as the control information that causes the display image 45 to be displayed, control information v the display image 45 to be displayed in association with the display section 47 in which the utterance content 48 on the display unit 217 (not illustrated in FIG. 4B) is to be displayed.

In the present exemplary embodiment, the inside of the display image 45 (see FIG. 4B) is the display section 47 in which utterance content 48 is to be displayed.

The CPU 11a generates, as control information that causes the display image 45 to be displayed, control information that causes the display image 45 to be associated with the display section 47.

Specifically, as the control information for associating the display image 45 with the display section 47, the CPU 11a generates control information that causes an image representing a balloon having a shape surrounding the display section 47 to be displayed on the display unit 217, as illustrated in FIG. 4B.

Then, in the present exemplary embodiment, when there is actual utterance by the nearby person 42 after the control information is generated, as illustrated in FIG. 4D, the utterance content 48 of the nearby person 42 is displayed in a region surrounded by the display image 45 including an image representing a balloon.

In other words, when there is actual utterance by the nearby person 42, the utterance content 48 is displayed in the display section 47 located inside of the display image 45.

The CPU 11a of the management server 300 generates control information that causes the device 200 to issue a notification appealing to the vision of the subject 41, for example, causes the display image 45 to be displayed, as control information that causes the device 200 to issue a notification indicating that there is a possibility of utterance.

Thus, in the present exemplary embodiment, a notification that the subject 41 can visually confirm is issued by the device 200.

### [Form of Notification Processing]

Here, the display image 45 is not limited to an image having a shape surrounding the display section 47. The shape of the display image 45 is not limited, and may be any shape as long as the subject 41 can visually confirm the display image 45.

Other examples of the display image 45 include a dot-shaped image.

When the dot-shaped image is displayed on the display unit 217, similarly to the image having a surrounding shape, the dot-shaped image is displayed in association with the nearby person 42.

When the dot-shaped image is displayed on the display unit 217, the utterance content 48 of the nearby person 42 is displayed around the dot-shaped image.

In addition, as the display image 45 displayed on the display unit 217 of the device 200, for example, an image of characters indicating that there is a possibility of utterance, such as “there is utterance possibility”, may be displayed.

The notification appealing to the vision of the subject 41 is not limited to an image, and may be issued by turning on a light source (not illustrated) provided in the device 200.

The notification appealing to the vision of the subject 41 may be issued by changing the color of an entire display screen displayed on the display unit 217 or changing the color of a part of the display screen, such as an edge of the display screen displayed on the display unit 217.

In addition, for example, control information that causes a vibration source (not illustrated) provided in the device 200 to be vibrated may be generated as control information that causes the device 200 to issue a notification indicating that there is a possibility of utterance by the nearby person 42. In this case, the subject 41 recognizes, based on the vibration of the device 200, that there is a possibility of utterance by the nearby person 42.

In addition, for example, control information that causes the speaker 216 (see FIG. 3) provided in the device 200 to emit sound or voice may be generated.

When the subject 41 is a hearing-impaired person, it is difficult to notify by sound, but when the subject 41 is not a hearing-impaired person, the subject 41 recognizes, by sound, that there is a possibility of utterance by the nearby person 42.

When the subject 41 is a hearing-impaired person, as illustrated in FIG. 4D, a display of the utterance content 48 allows the subject 41 to recognize that the nearby person 42 is uttering.

Here, the utterance content 48 is displayed with a delay from the actual utterance by the nearby person 42. When the display of the utterance content 48 is delayed, a status may occur in which the utterance content 48 is not displayed yet although the actual utterance by the nearby person 42 has already been started.

In this case, a status may occur in which the subject 41 erroneously recognizes that the nearby person 42 is not uttering, and the subject 41 utters while the nearby person 42 is uttering.

Meanwhile, in the present exemplary embodiment, as described above, the subject 41 is notified that there is a possibility of utterance before the actual utterance by the nearby person 42 is started.

In this case, when notified that there is a possibility of utterance, the subject 41 refrains from uttering his or her own utterance. In this case, a status is less likely to occur in which the utterance of the subject 41 is started after utterance by the nearby person 42 is started.

The information processing system 1 according to the present exemplary embodiment also functions effectively when the subject 41 is other than a hearing-impaired person.

Even if the subject 41 is not a hearing-impaired person, when the subject 41 is notified that there is a possibility of utterance by the nearby person 42, the subject 41 is less likely to utter after a start of utterance by the nearby person 42.

### [Another Display Example]

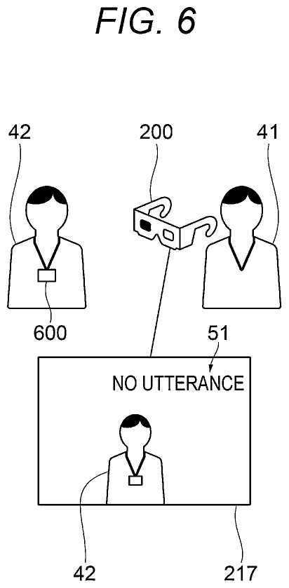

FIG. 6 is a diagram illustrating another display example on the display unit 217 of the device 200.

FIG. 6 illustrates a display example in a status in which there is no utterance by the nearby person 42 and there is no possibility of utterance by the nearby person 42.

When there is no utterance by the nearby person 42, the CPU 11a of the management server 300 may generate control information that causes the device 200 to issue a notification indicating that there is no utterance.

Accordingly, in this case, as illustrated in FIG. 6, an image 51 indicating that there is no utterance is displayed on the display unit 217 of the device 200.

The image 51, illustrated in FIG. 6, indicating that there is no utterance is an image including characters “no utterance”. The image 51 indicating that there is no utterance is displayed, and thus the subject 41 recognizes that there is no utterance by the nearby person 42.

Note that the image 51 indicating that there is no utterance is not limited to an image including characters and may be an image other than an image including characters, such as a symbol or a figure.

Here, a case is assumed where a possibility of utterance by the nearby person 42 occurs from the status illustrated in FIG. 6.

In this case, the CPU 11a of the management server 300 generates control information that causes the display on the device 200 to be switched to the display illustrated in FIG. 4B.

Specifically, the CPU 11a generates control information that causes the image 51 indicating that there is no utterance to be erased and causes the display image 45 illustrated in FIG. 4B to be displayed on the display unit 217.

When the display image 45 illustrated in FIG. 4B is displayed, the subject 41 recognizes that there is a possibility of utterance by the nearby person 42.

### [Another Processing Example]

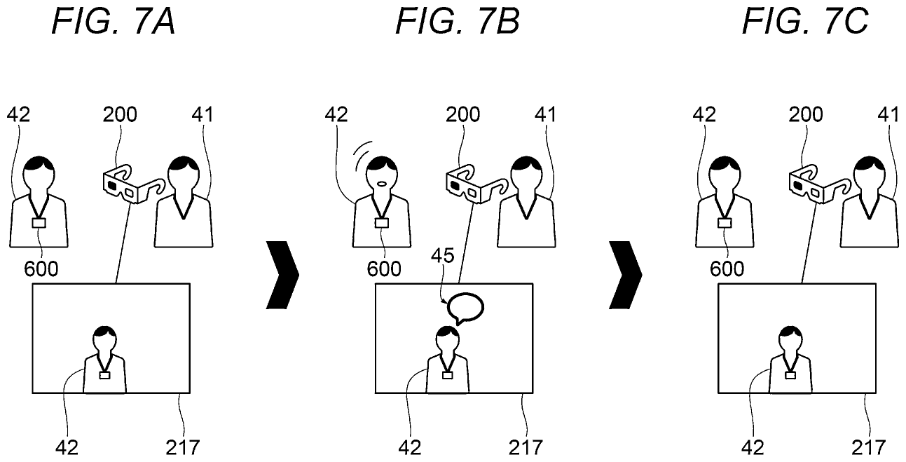

FIGS. 7A to 7C are diagrams illustrating another processing example.

Processing in a case where there is no actual utterance by the nearby person 42 will be described.

In this processing example, similarly to the above, first, as illustrated in FIGS. 7A and 7B, a possibility of utterance by the nearby person 42 occurs, and accordingly, the display image 45 is displayed on the display unit 217 of the device 200.

Thereafter, in this processing example, the status shows that there is no actual utterance by the nearby person 42.

In this case, in this processing example, as illustrated in FIG. 7C, the display image 45 corresponding to this nearby person 42 is erased.

When there is no actual utterance by the nearby person 42 after the control information that causes the display image 45 to be displayed on the display unit 217 is generated, the CPU 11a generates control information that causes the display image 45 displayed on the display unit 217 to be erased.

Specifically, when there is no actual utterance by the nearby person 42 corresponding to the displayed display image 45 during a period from generation of the control information that causes the display image 45 to be displayed to lapse of a predetermined time, or during a period from display of the display image 45 on the display unit 217 to lapse of a predetermined time, the CPU 11a generates control information that causes the display image 45 to be erased.

In this case, accordingly, the device 200 erases the display image 45. As a result, as illustrated in FIGS. 7B and 7C, the display image 45 displayed on the display unit 217 is erased.

### [Another Processing Example]

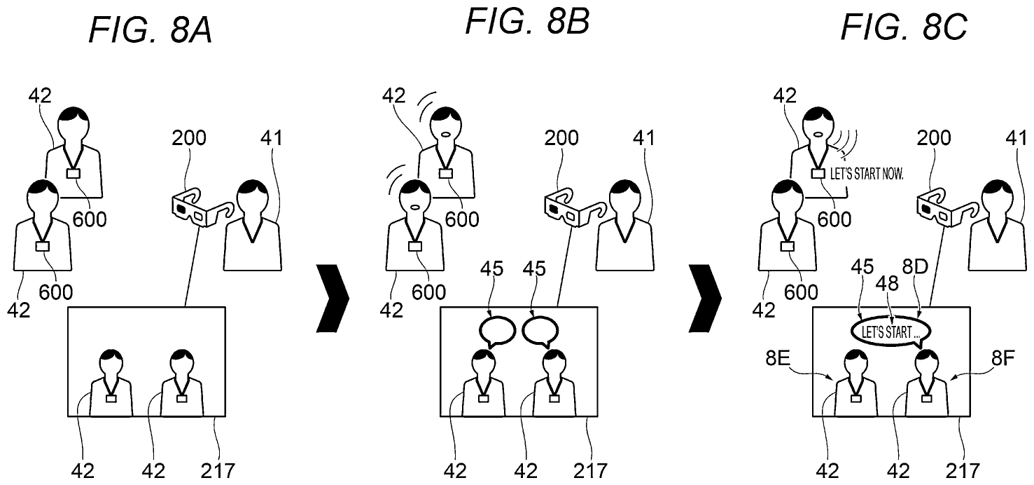

FIGS. 8A to 8C are diagrams illustrating other processing examples.

When a plurality of nearby persons 42 appearing on the display unit 217 of the device 200 is in a particular status, the CPU 11a of the management server 300 generates, as the control information, control information that causes the display image 45 to be displayed in such a manner that the display image 45 is associated with each of the plurality of nearby persons 42.

Thus, in this case, as illustrated in FIG. 8B, the display image 45 is displayed on the display unit 217 of the device 200 in such a manner that the display image 45 is associated with each of the plurality of nearby persons 42.

In this case, the subject 41 referring to the display unit 217 of the device 200 recognizes that there is a possibility of utterance by the plurality of nearby persons 42.

Thereafter, when the nearby person 42 included in the plurality of nearby persons 42 actually utters, the utterance content 48 is displayed in a region surrounded by the display image 45 displayed in association with the nearby person 42 who has actually uttered, as illustrated by the reference numeral 8D in FIG. 8C.

In this processing example illustrated in FIGS. 8A to 8C, for another nearby person 42 indicated by the reference numeral 8E in FIG. 8C who has not actually uttered, the display image 45 displayed in association with the other nearby person 42 is deleted as illustrated in FIGS. 8B and 8C.

Although illustration is omitted, when a possibility of utterance occurs in another nearby person 42, indicated by the reference numeral 8E, in the state illustrated in FIG. 8C, the display image 45 corresponding to the other nearby person 42 is displayed again.

In the present exemplary embodiment, when there is a possibility of utterance by another nearby person 42 occurs while the nearby person 42 indicated by the reference numeral 8F who is some of the nearby persons 42 are uttering, a new display image 45 corresponding to the other nearby person 42 is displayed while the display image 45 and the utterance content 48 corresponding to that some of the nearby persons 42 are displayed.

### [Another Processing Example]

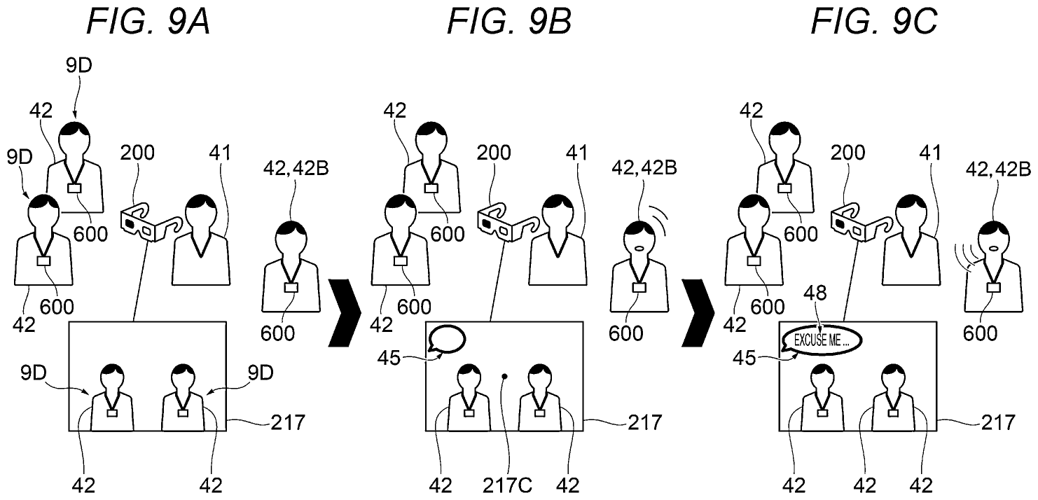

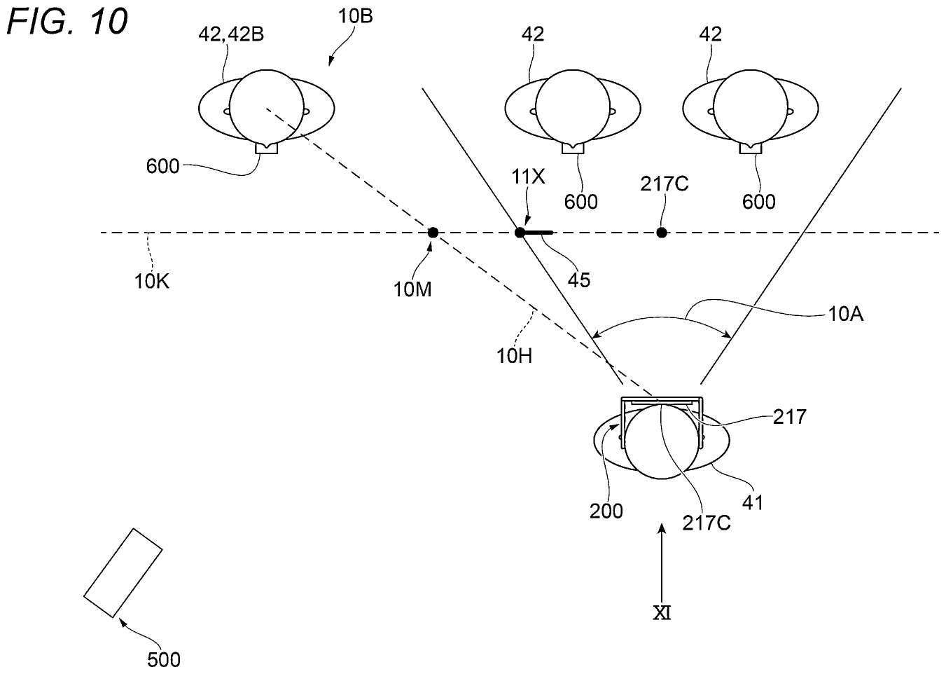

FIGS. 9A to 9C and 10 are diagrams illustrating another processing example. FIG. 10 illustrates a state in which the device 200, the nearby person 42, and the subject 41 are viewed from above in a vertical direction.

In the processing example illustrated in FIGS. 9A to 9C and 10, as illustrated in FIG. 10, some of the nearby persons 42 indicated by the reference numeral 10B are out of an imaging range 10A of the device camera 214 (not illustrated in FIG. 10) provided in the device 200.

The imaging range 10A can also be regarded as a range of a field of view of the subject 41 visually recognizing the front of the subject with the device 200, and in the processing example illustrated in FIGS. 9A to 9C and 10, some of the nearby persons 42 indicated by the reference numeral 10B are outside of the range of the field of view.

Hereinafter, that some of the nearby persons 42 are referred to as “non-displayed nearby person 42B”.

As illustrated in FIG. 9A, two nearby persons 42 indicated by the reference numeral 9D other than the non-displayed nearby person 42B are displayed on the display unit 217 of the device 200, and the non-displayed nearby person 42B is not displayed on the display unit 217 of the device 200.

Furthermore, in the processing example illustrated in FIGS. 9A to 9C and 10, the non-displayed nearby person 42B not appearing on the display unit 217 of the device 200 is in a particular status, which is a status in which there is a possibility of utterance by the non-displayed nearby person 42B.

In this case, the CPU 11a of the management server 300 generates control information that causes the display image 45 indicating that there is a possibility of utterance by the non-displayed nearby person 42B to be displayed on the display unit 217.

In the present exemplary embodiment, when there is a possibility of utterance by the non-displayed nearby person 42B, control information that causes the display image 45 to be displayed on the display unit 217 is also generated.

Thus, in this processing example, as illustrated in FIG. 9B, the display image 45 corresponding to the non-displayed nearby person 42B is displayed on the display unit 217 of the device 200.

Referring to the display unit 217 in the state of FIG. 9 B, the subject 41 recognizes that there is a possibility of utterance by the nearby person 42 located at a place out of the field of view of the subject 41.

When the non-displayed nearby person 42B actually utters, as illustrated in FIG. 9 C, the utterance content 48 of the non-displayed nearby person 42B is displayed in association with the display image 45 corresponding to the non-displayed nearby person 42B.

Also in this processing example, the utterance content 48 of the non-displayed nearby person 42B is displayed in a region surrounded by the display image 45 corresponding to the non-displayed nearby person 42B.

In the processing example illustrated in FIGS. 9A to 9C and 10, the utterance content 48 of the non-displayed nearby person 42B not appearing on the display unit 217 of the device 200 is also displayed on the display unit 217 of the device 200.

In this processing example illustrated in FIGS. 9A to 9C and 10, when the display image 45 corresponding to the non-displayed nearby person 42B is displayed on the display unit 217 of the device 200, as illustrated in FIG. 9B, the display is performed so that the subject 41 can know the direction in which the non-displayed nearby person 42B exists.

In FIG. 9B, the non-displayed nearby person 42B is located to the left of the forward of the device 200, and the display image 45 corresponding to the non-displayed nearby person 42B is also located to the left of a center 217C of the display unit 217 in the drawing.

In the present exemplary embodiment, the display position of the display image 45 corresponding to the non-displayed nearby person 42B changes in accordance with the position of the non-displayed nearby person 42B.

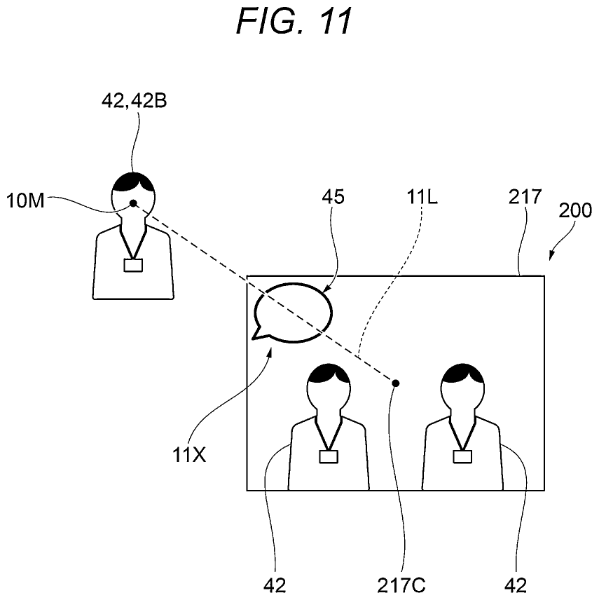

FIG. 11 is a diagram when the display unit 217 and the nearby person 42 are viewed from a direction indicated by an arrow XI in FIG. 10.

As illustrated in FIG. 11, the CPU 11a generates control information that causes the display image 45 corresponding to the non-displayed nearby person 42B to be displayed in a portion of the display unit 217 located on a straight line 11L connecting the non-displayed nearby person 42B and the center 217C of the display unit 217.

Details will be described with reference to FIG. 10.

Here, a virtual plane 10K along the display unit 217 of the device 200 is assumed. Furthermore, a line 10H connecting a center of the subject 41 to the non-displayed nearby person 42B is assumed.

Furthermore, here, a case is assumed where the non-displayed nearby person 42B is projected onto the virtual plane 10K.

Specifically, a case is assumed where the non-displayed nearby person 42B is projected onto the virtual plane 10K from the place where the non-displayed nearby person 42B is located toward a direction in which the line 10H is directed.

In this case, on the virtual plane 10K, the non-displayed nearby person 42B is located at a position indicated by the reference numeral 10M.

Hereinafter, this position of the non-displayed nearby person 42B in a case where the non-displayed nearby person 42B is projected onto this virtual plane 10K along the display unit 217 is referred to as a “on-plane position 10M”.

As control information that causes the display image 45 (see FIG. 11) for the non-displayed nearby person 42B to be displayed on the display unit 217, the CPU 11a generates control information that causes the display image 45 to be displayed in a direction located on a straight line 11L connecting the on-plane position 10M and the center 217C of the display unit 217 in the display unit 217.

Thus, the display image 45 is displayed at a position indicated by the reference numeral 11X in FIG. 11 on the display unit 217 of the device 200.

The subject 41 can specify in which direction the non-displayed nearby person 42B having a possibility of utterance is located by referring to the display unit 217 illustrated in FIG. 11.

When the status information on the non-displayed nearby person 42B not appearing in the display unit 217 of the device 200 is acquired based on the video in which the non-displayed nearby person 42B appears, the status information related to the non-displayed nearby person 42B is acquired based on the video acquired by the overall camera 500 (see FIG. 10).

Specifically, in this case, the non-displayed nearby person 42B is specified based on the video acquired by the overall camera 500 and the face information registered in the database (see FIG. 5), and the status information of the specified non-displayed nearby person 42B is acquired based on the video.

When the display image 45 is displayed on the display unit 217 of the device 200, it is necessary to specify the position of the specified non-displayed nearby person 42B.

In this case, for example, the CPU 11a of the management server 300 analyzes the video obtained by the overall camera 500 and specifies the position of the non-displayed nearby person 42B.

Furthermore, in this case, the CPU 11a of the management server 300 analyzes the video acquired by the overall camera 500 and specifies the position of the center 217C of the display unit 217 of the device 200 worn by the subject 41 and the orientation of the device 200.

Then, the CPU 11a of the management server 300 specifies the on-plane position 10M based on the position of the non-displayed nearby person 42B, the position of the center 217C of the display unit 217 of the device 200, and the orientation of the device 200.

Next, the CPU 11a of the management server 300 determines the display position of the display image 45 on the display unit 217 based on the specified on-plane position 10M and the specified position of the center 217C of the display unit 217.

Then, the CPU 11a of the management server 300 generates control information including information related to the determined display position.

The device 200 performs display control on the display unit 217 in accordance with the control information.

Accordingly, as illustrated in FIG. 11, the display image 45 is displayed on the straight line 11L connecting the on-plane position 10M and the center 217C of the display unit 217 on the display unit 217 of the device 200.

When the status specified by the acquired status information is a status in which one nearby person 42 is looking at another nearby person 42, the CPU 11a may generate control information that causes the device 200 to issue a notification indicating that there is a possibility of utterance by the other nearby person 42.

In the above description, it is determined whether there is a possibility of utterance by the nearby person 42 based on the status information of the nearby person 42, but not necessarily, and it may be determined whether there is a possibility of utterance by another nearby person 42 based on the status information of one nearby person 42.

When determining that there is a possibility of utterance by the other nearby person 42, the CPU 11a generates, for example, control information for associating the display image 45 with the other nearby person 42.

Specifically, the CPU 11a generates, for example, control information for associating the display image 45 with the other nearby person 42 appearing on the display unit 217.

Specifically, for example, when one nearby person 42 appearing in a video obtained by the device camera 214 continuously views another nearby person 42 appearing in the video for more than a predetermined time, the CPU 11a determines a status in which there is a possibility of utterance by the other nearby person 42.

Then, in this case, the CPU 11a generates control information that causes the display image 45 to be displayed in association with the other nearby person 42.

### [Description of Flow of Processing]

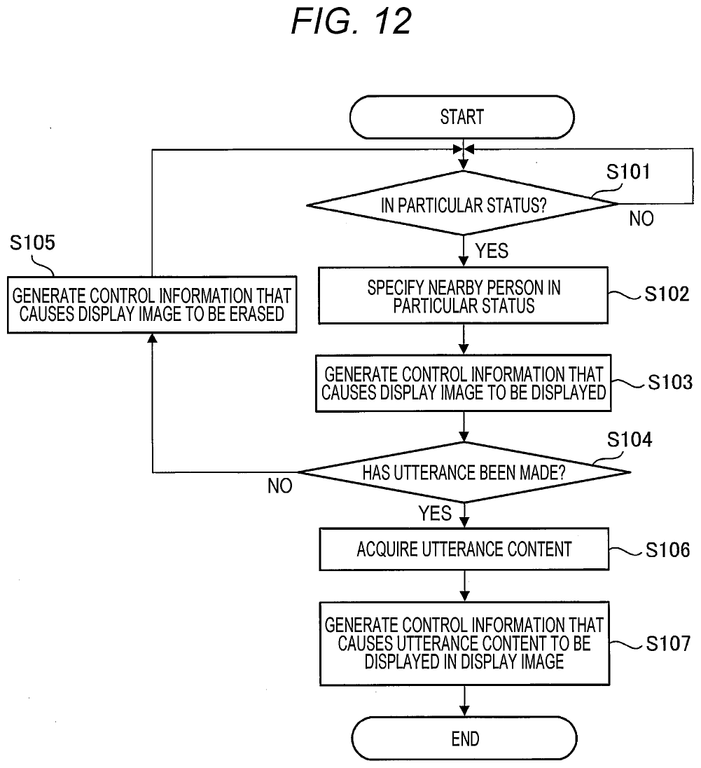

FIG. 12 is a flowchart illustrating a flow of processing executed when the notification processing is performed.

The flow of a series of processing described above will be described.

In the present exemplary embodiment, first, the CPU 11a of the management server 300 determines, for each of the nearby persons 42 located around the subject 41, whether the status of the nearby person 42 is the particular status described above (step S101).

Next, when determining that the status of the nearby person 42 is the particular status, the CPU 11a specifies the nearby person 42 who is in the particular status (step S102).

Thereafter, the CPU 11a generates control information that causes the display image 45 corresponding to the nearby person 42 in the particular status to be displayed on the display unit 217 (step S103).

Accordingly, the display image 45 indicating that there is a possibility of utterance is displayed on the display unit 217 of the device 200.

Thereafter, the CPU 11a determines whether the specified nearby person 42 has actually uttered based on the voice information of the nearby person 42 specified as being in the particular status (step S104).

Then, when not determining that the specified nearby person 42 has actually uttered, the CPU 11a generates control information that causes the display image 45 corresponding to the nearby person 42 to be erased (step S105). Accordingly, the display image 45 displayed on the display unit 217 of the device 200 is erased.

On the other hand, when determining that the specified nearby person 42 has actually uttered, the CPU 11a analyzes the voice information and acquires the utterance content 48 corresponding to the nearby person 42 (step S106).

Next, the CPU 11a generates control information that causes the utterance content 48 to be displayed in the display image 45 (step S107).

In this case, the CPU 11a generates control information that causes the utterance content 48 to be displayed in the display image 45 displayed in association with the specified nearby person 42.

Accordingly, the utterance content 48 is displayed in the display image 45.

### [Notification Processing for End of Utterance]

Next, notification processing for an end of utterance will be described.

The notification processing for a possibility of utterance has been described above.

In addition, a notification indicating that there is a possibility of an end of utterance or a notification indicating that utterance has ended may be issued to the subject 41 by the device 200.

In the present exemplary embodiment, as described above, the CPU 11a of the management server 300 acquires the status information which is information related to the status of the nearby person 42 before actually uttering. Then, in the case of, when there is a possibility of utterance by the nearby person 42, as described above, the CPU 11a causes a notification indicating that there is a possibility of utterance to be issued.

Hereinafter, in the specification, the status information that is information related to the status of the nearby person 42 before actually uttering is referred to as “pre-utterance status information”.

Furthermore, in the processing described below, after the nearby person 42 starts an actual utterance, the CPU 11a of the management server 300 acquires status information that is information related to the status of the nearby person 42 who is uttering.

Hereinafter, in the specification, the status information related to the status of the nearby person 42 who is uttering is referred to as “mid-utterance status information”. Then, when the status specified by the acquired mid-utterance status information is a particular status, the CPU 11a also generates control information used for controlling the device 200.

Specifically, the CPU 11a generates, as the control information, control information that causes the device 200 to issue a notification indicating that there is a possibility of an end of utterance by the nearby person 42 (hereinafter, referred to as an “end possibility suggestion notification”).

In other words, the CPU 11a generates, as the control information, control information that causes the device 200 to issue an end possibility suggestion notification indicating that there is a possibility of an end of utterance by the nearby person 42 to be displayed in the display image 45.

When the status specified by the acquired mid-utterance status information is a particular status, the CPU 11a generates control information that causes the device 200 to issue a notification indicating that the utterance by the nearby person 42 has ended (hereinafter, referred to as an “end notification”).

In other words, the CPU 11a generates, as the control information, control information that causes the device 200 to issue an end notification indicating that the utterance by the nearby person 42 to be displayed in the display image 45 has ended.

### [End Possibility Suggestion Notification]

The end possibility suggestion notification will be described.

When the status specified by the acquired mid-utterance status information is a status in which there is a possibility of an end of utterance by the nearby person 42, the CPU 11a generates control information that causes the device 200 to issue the end possibility suggestion notification.

When the status specified by the acquired mid-utterance status information is, for example, the following status, the CPU 11a generates control information that causes the device 200 to issue the end possibility suggestion notification.
When the status specified by the voice information is a particular status such as a decrease in a tone of the voice of the nearby person 42 or a decrease in a pitch of the utterance
When the nearby person 42 performs a predetermined specific action such as dropping a hand raised by the nearby person 42

### [End Notification]

Next, the end notification will be described.

When the status specified by the acquired mid-utterance status information indicates a status in which the utterance by the nearby person 42 has ended, the CPU 11a generates control information that causes the device 200 to issue the end notification.

Specifically, the CPU 11a generates control information that causes the device 200 to issue the end notification when the status specified by the acquired mid-utterance status information is, for example, any of the following statuses.
When voice information is not acquired
When the expression of the nearby person 42 becomes a particular state such as a state in which the mouth of the nearby person 42 is closed

The CPU 11a acquires the mid-utterance status information of the nearby person 42 based on the voice information on the nearby person 42 and the video in which the nearby person 42 appears.

Specifically, the CPU 11a acquires the mid-utterance status information of the nearby person 42 based on the voice information acquired by the individual microphone 600 or the video acquired by the device camera 214 or the overall camera 500.

Then, when the status specified by the mid-utterance status information is a predetermined status, the CPU 11a generates control information that causes the device 200 to issue the end possibility suggestion notification or the end notification.

Note that the information used for acquiring the pre-utterance status information and the information used for acquiring the mid-utterance status information may be different from each other.

Specifically, for example, regarding the pre-utterance status information, the pre-utterance status information may be acquired based on the video in which the nearby person 42 appears, and regarding the mid-utterance status information, the mid-utterance status information may be acquired based on the voice information of the nearby person 42.

Since the nearby person 42 does not clearly utter in many cases at the time of acquisition of the pre-utterance status information, accuracy of determination as to the possibility of uttering is more likely to increase when the pre-utterance status information is acquired based on the video in which the nearby person 42 appears.

On the other hand, since the nearby person 42 is actually uttering at the time of acquisition of the mid-utterance status information, acquiring the mid-utterance status information based on the voice information is more likely to increase the possibility of the end of utterance or the accuracy of determination on the end of utterance as compared with acquiring the mid-utterance status information based on the video.

The control information that causes the device 200 to issue the end possibility suggestion notification or the end notification is transmitted to the device 200 in a similar manner to the above.

Accordingly, in the present exemplary embodiment, the device 200 performs control based on the control information and provides the end possibility suggestion notification or the end notification to the subject 41.

Thus, the subject 41 recognizes that the utterance by the nearby person 42 is about to end or the utterance by the nearby person 42 has ended.

### [Specific Examples of Processing]

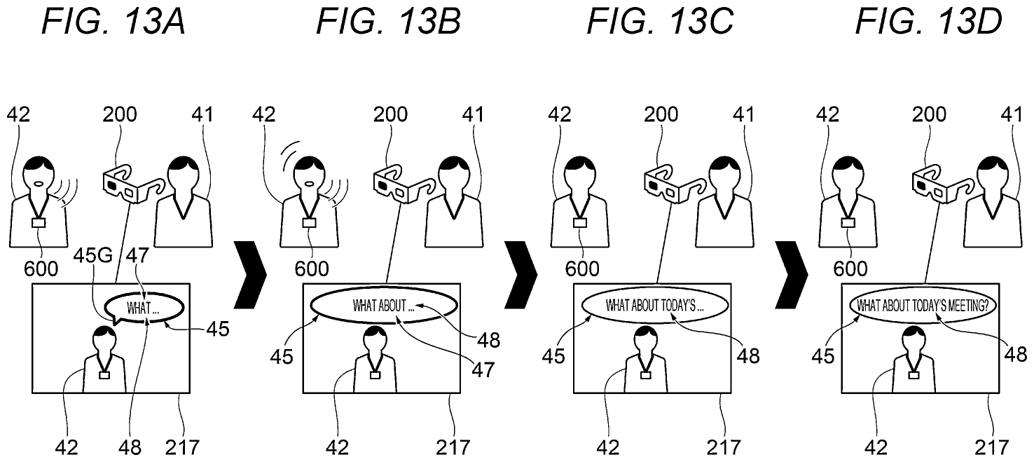

FIGS. 13A to 13D are diagrams illustrating specific examples of processing.

FIG. 13A illustrates a status in which the nearby person 42 is uttering.

In the present exemplary embodiment, in the case of the status illustrated in FIG. 13A, the utterance content 48 is displayed in the region surrounded by the display image 45.

The CPU 11a of the management server 300 acquires the mid-utterance status information when the nearby person 42 is uttering as illustrated in FIG. 13A.

Specifically, the CPU 11a acquires the mid-utterance status information of the nearby person 42 with which the display image 45 is associated, based on the video acquired by the overall camera 500 or the device camera 214 or the voice information acquired by the individual microphone 600.

Then, when the status specified by the acquired mid-utterance status information is a status in which there is a possibility of an end of utterance by the nearby person 42, the CPU 11a generates control information that causes the device 200 to issue the end possibility suggestion notification.

When the status specified by the acquired mid-utterance status information indicates a status in which the utterance by the nearby person 42 has been ended, the CPU 11a generates control information that causes the device 200 to issue the end notification.

In FIG. 13B, the status specified by the mid-utterance status information is the status of the display unit 217 of the device 200 when a status in which there is a possibility of an end of utterance by the nearby person 42.

When there is a possibility of an end of utterance by the nearby person 42, the CPU 11a generates, as described above, control information that causes the device 200 to issue the end possibility suggestion notification.

In this processing example, the CPU 11a generates control information that changes the display image 45 displayed on the display unit 217 of the device 200 as the control information that causes the device 200 to issue the end possibility suggestion notification.

Hereinafter, in the specification, the control information that causes the device 200 to issue the end possibility suggestion notification is referred to as “first control information”.

In this processing example, the CPU 11a generates, as the first control information, control information that changes the display image 45 displayed in association with the display section 47 of the utterance content 48 (see FIG. 13A) of the nearby person 42.

Here, the display image 45 can be regarded as a corresponding display image to be displayed in association with the display section 47 of the utterance content 48 of the nearby person 42. In the present exemplary embodiment, the display image 45 representing a balloon is displayed as the corresponding display image.

The CPU 11a generates control information that changes the display image 45 representing the balloon, which is an example of the corresponding display image, as the first control information that causes the device 200 to issue the end possibility suggestion notification.

Specifically, the CPU 11a generates, as the first control information that changes the corresponding display image, control information that changes the shape of the display image 45 representing a balloon, which is displayed so as to surround the display section 47.

Specifically, the CPU 11a generates, as the first control information for changing the corresponding display image, control information that causes a protrusion 45G (see FIG. 13A) provided as a part of the display image 45 representing the balloon to be erased.

Accordingly, in the present exemplary embodiment, as illustrated in FIGS. 13A and 13C, the protrusion 45G is erased.

In the present exemplary embodiment, the protrusion 45G provided in the display image 45 displayed in association with the nearby person 42 who is in the status in which there is a possibility of an end of utterance is erased.

The subject 41 recognizes that the protrusion 45G has been erased, and thud recognizes that there is a possibility of an end of utterance by the nearby person 42.

In the present exemplary embodiment, as described above, when the status specified by the pre-utterance status information is a particular status, the CPU 11a generates control information that causes the display image 45 representing a balloon to be displayed on the display unit 217 provided in the device 200.

Accordingly, in the present exemplary embodiment, first, as illustrated in FIG. 13A, the display image 45 representing a balloon is displayed in association with the nearby person 42 on the display unit 217 of the device 200.

The display image 45 is provided with the protrusion 45G that protrudes toward the nearby person 42.

In the present exemplary embodiment, the nearby person 42 who has a possibility of utterance or the nearby person 42 who is uttering is located ahead in a direction in which the protrusion 45G protrudes.

The CPU 11a generates, as the first control information that causes the device 200 to issue an end suggestion notification, control information that causes a display mode of the display image 45 displayed on the display unit 217 to be changed.

Specifically, the CPU 11a generates, as the first control information, control information that causes the protrusion 45G of the display image 45 not to be displayed.

Accordingly, in the present exemplary embodiment, as described above, the protrusion 45G of the display image 45 is not displayed.

As described above, when the utterance by the nearby person 42 has actually ended, the CPU 11a generates control information that causes the device 200 to issue an end notification which is a notification indicating that the utterance has ended.

Hereinafter, this control information that causes the device 200 to issue the end notification is referred to as “second control information”.

In this case, the CPU 11a also generates, as the second control information, for example, control information that changes the display image 45 displayed on the display unit 217 of the device 200.

Specifically, the CPU 11a generates, as the second control information, control information that changes the display image 45 displayed in association with the display section 47 of the utterance content 48 of the nearby person 42.

Specifically, the CPU 11a generates, as the second control information, control information that further changes the display mode of the display image 45 after the display mode is changed by the first control information that changes the display mode of the display image 45.

More specifically, the CPU 11a generates, as the second control information, control information that changes the thickness of a line constituting the display image 45.

Thus, in the present exemplary embodiment, as illustrated in FIGS. 13B and 13C, the line constituting the display image 45 displayed on the display unit 217 of the device 200 is thinner.

In other words, in the present exemplary embodiment, the line constituting the display image 45 displayed in association with the nearby person 42 uttering is thinner.

Thus, the subject 41 recognizes that the utterance by the nearby person 42 has ended.

In the present exemplary embodiment, there is a time difference between a timing at which the utterance by the nearby person 42 ends and a timing at which the utterance content 48 at the end of the utterance by the nearby person 42 is displayed on the display unit 217.

In this case, in the present exemplary embodiment, as illustrated in FIGS. 13C and 13D, after the timing of the end of the utterance by the nearby person 42, the display processing of the utterance content 48 is still continuously performed until all of the utterance content 48 is displayed.

In other words, in the present exemplary embodiment, even when the line constituting the display image 45 is thinner, the display processing of the utterance content 48 does not end, and the display processing is continuously performed until all of the utterance content 48 is displayed.

The subject 41 can recognize the end of utterance by the nearby person 42 also by recognizing the end of the display processing of the utterance content 48.

Meanwhile, in the present exemplary embodiment, the display processing is continuously performed until all of the utterance content 48 is displayed even though the utterance by the nearby person 42 has already ended.

In this case, the subject 41 is likely to erroneously recognize that the nearby person 42 is still uttering although the nearby person 42 has already finished uttering.

In this case, a blank time during which no utterance is made is likely to occur between the end of utterance by the nearby person 42 and the start of utterance by the subject 41.

Meanwhile, as in the present exemplary embodiment, when the end possibility suggestion notification or the end notification is issued, the subject 41 can recognize the end of utterance by the nearby person 42 at an earlier stage.

In this case, the subject 41 can make his or her own utterance shortly after the end of utterance by the nearby person 42.

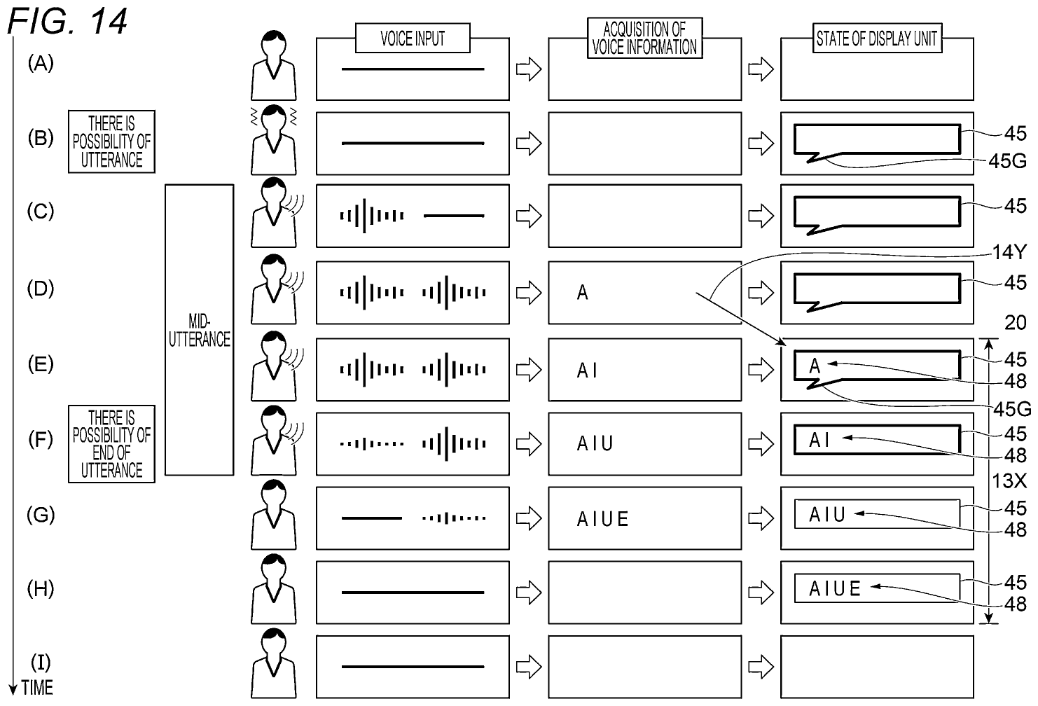

FIG. 14 is a diagram illustrating a series of flows of the display processing.

The part (A) of FIG. 14 illustrates a status in which there is no utterance by the nearby person 42 and there is no possibility of utterance by the nearby person 42, and in this case, no voice is detected. In this case, the CPU 11a does not generate control information that causes the display image 45 to be displayed, and the display image 45 is not displayed on the display unit 217 of the device 200.

The part (B) of FIG. 14 illustrates a status in which there is a possibility of utterance, and in this case, the display image 45 is displayed on the display unit 217 of the device 200. The parts (C) to (F) of FIG. 14 illustrate a status in which the nearby person 42 is uttering.

In this case, the CPU 11a acquires the utterance content 48 and furthermore, generates control information that causes the utterance content 48 to be displayed.

Accordingly, as indicated by the reference numeral 13X, the utterance content 48 is sequentially displayed on the display unit 217 of the device 200. Specifically, the utterance content 48 is sequentially displayed inside of the display image 45 displayed on the display unit 217 of the device 200.

In the present exemplary embodiment, there is a time difference between a timing at which the voice information by the CPU 11a is acquired and a timing at which the utterance content 48 is displayed on the display unit 217 of the device 200.

Therefore, in the present exemplary embodiment, as indicated by an arrow 14Y in FIG. 14, the utterance content 48 is displayed with a delay from the acquisition of the voice information by the CPU 11a.

The part (F) of FIG. 14 illustrates a status in which there is a possibility of an end of the utterance by the nearby person 42.

In this case, in the present exemplary embodiment, the protrusion 45G (see the part (E) of FIG. 14) which has been displayed as a part of the display image 45 is erased.

The part (G) of FIG. 14 and the subsequent drawings illustrate a status in which the utterance by the nearby person 42 has ended. In this case, as illustrated in the parts (G) and (H) of FIG. 14, the line constituting the display image 45 is thinner.

In the present exemplary embodiment, at least one of the shape, the thickness, or the color of the display image 45 is changed when there is a possibility of an end of utterance, and at least one of the shape, the thickness, or the color of the display image 45 is further changed when the utterance has actually ended.

The case where the shape of the display image 45 is changed when there is a possibility of an end of utterance and the thickness of the line constituting the display image 45 is changed when the utterance actually has ended has been described above as an example.

In other words, the case where the shape of the display image 45 is first changed, and then the thickness of the line constituting the display image 45 is changed has been described above as an example.

As another example, for example, the thickness of the line constituting the display image 45 may be changed first, and then the shape of the display image 45 may be changed.

Alternatively, the shape of the display image 45 may be changed first, and then the shape of the display image 45 may be further changed.

In addition, first, the line constituting the display image 45 may be thinner, and then the line constituting the display image 45 may be much thinner. Alternatively, the line constituting the display image 45 may be thicker, and then the line constituting the display image 45 may be much thicker.

In addition, the color of the display image 45 may be changed first, and then the color of the display image 45 may be further changed.

### [Form of Notification Processing]

In the present exemplary embodiment, at an end of utterance, a notification appealing to the vision of the subject 41 is also issued, as in the case of a start of utterance.

Specifically, in the present exemplary embodiment, as described above, a first change of the display image 45 is performed as the notification appealing to the vision of the subject 41, and then a second change of the display image 45 is performed.

As the notification appealing to the vision of the subject 41 at the time of an end of utterance, in addition, for example, an image of characters such as “there is possibility of end of utterance” or “end of utterance” may be displayed on the display unit 217 of the device 200.

The notification appealing to the vision of the subject 41 at the time of an end of utterance may be issued, for example, by turning on or off a light source (not illustrated) provided in the device 200.

The notification appealing to the vision of the subject 41 at the time of an end of utterance may be issued by changing the color of the entire display screen displayed on the display unit 217 or changing the color of a part of the display screen such as an edge of the display screen displayed on the display unit 217.

The notification at the time of an end of utterance may be issued, for example, by vibrating a vibration source (not illustrated) provided in the device 200.

The notification at the time of an end of utterance may be issued, for example, by emitting sound or voice from the speaker 216 (see FIG. 3) provided in the device 200.

When the subject 41 is a hearing-impaired person, it is difficult to make a notification by sound. However, when the subject 41 is not a hearing-impaired person, it is possible to make an end possibility notification or an end notification to the subject 41 by sound.

### [Description of Flow of Processing]

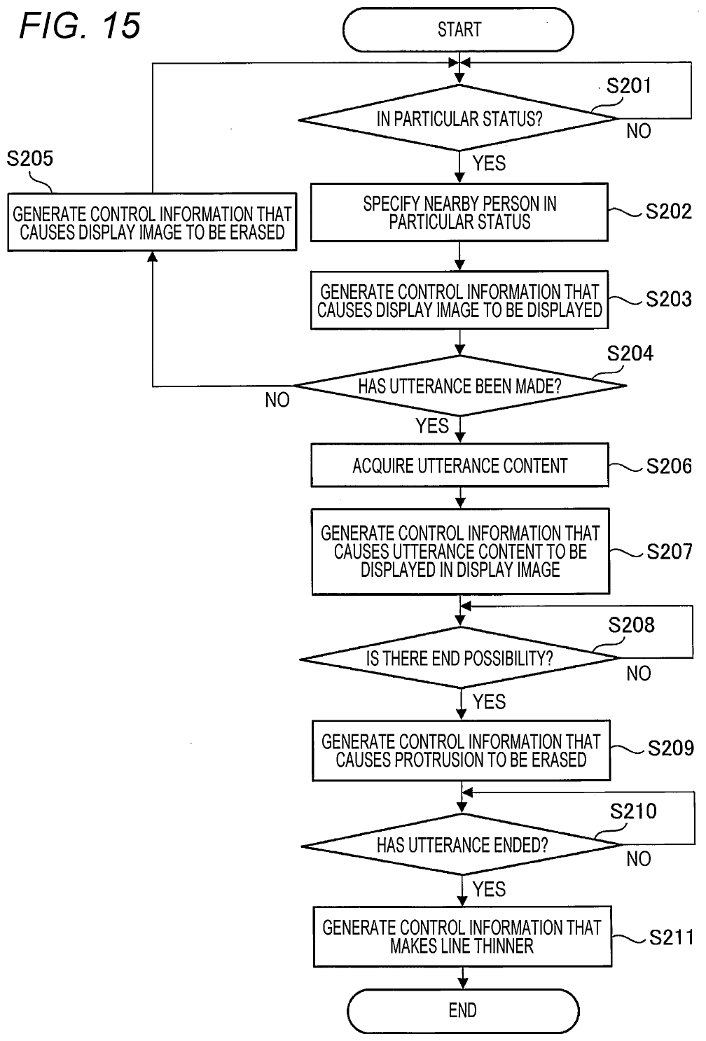

FIG. 15 is a flowchart illustrating a flow of processing when the notification processing is also performed at an end of utterance. Note that processing in step S201 to step S207 in FIG. 15 is the same as the processing in step S101 to step S107 illustrated in FIG. 12.

In the present exemplary embodiment, first, similarly to the above, the CPU 11a determines, for each nearby person 42 located around the subject 41, whether the status specified by the pre-utterance status information is the particular status described above (step S201).

Next, when determining that the status specified by the pre-utterance status information is the particular status, the CPU 11a specifies the nearby person 42 who is in the particular status (step S202).

In other words, when determining that the status specified by the pre-utterance status information is a status in which there is a possibility of utterance, the CPU 11a specifies the nearby person 42 who has a possibility of utterance.

Next, the CPU 11a generates control information that causes the display image 45 corresponding to the nearby person 42 specified as being in the particular status to be displayed on the display unit 217 (step S203).

Accordingly, the display image 45 illustrated in the part (B) of FIG. 14 is displayed on the display unit 217 of the device 200 so as to correspond to the nearby person 42 who has a possibility of utterance.

The displayed display image 45 is provided with a protrusion 45G.

Thereafter, based on the voice information of the nearby person 42 to be displayed in the display image 45, the CPU 11a determines whether the nearby person 42 has actually uttered (step S204).

When not determining that the nearby person 42 has actually uttered, the CPU 11a generates control information that the display image 45 to be erased (step S205). Accordingly, the display image 45 displayed on the display unit 217 of the device 200 is erased.

On the other hand, when determining that the nearby person 42 has actually uttered, the CPU 11a analyzes the voice information and acquires the utterance content 48 (step S206).

Next, the CPU 11a generates control information that causes the utterance content 48 to be displayed in the display image 45 (step S207). Accordingly, as indicated by the reference numeral 13X in FIG. 14, the utterance content 48 is displayed in the display image 45.

Although in the processing example illustrated in FIGS. 13A to 13D and 14, a case has been described where the display image 45 formed by a thick line is displayed at a stage where there is a possibility of utterance by the nearby person 42, the form of representation of the display image 45 is not limited to this case.

At a stage where there is a possibility of utterance by the nearby person 42, the display image 45 constituted by a thin line may be displayed. Then, when actual utterance by the nearby person 42 is started, the line constituting the display image 45 may be thicker.

Next, in step S208, the CPU 11a determines whether there is a possibility of an end of utterance by the nearby person 42.

Then, when determining that there is a possibility of an end of utterance by the nearby person 42, the CPU 11a generates control information that causes the protrusion 45G to be erased (step S209). Accordingly, as described above, the protrusion 45G is erased.

Next, the CPU 11a determines whether the utterance by the nearby person 42 has ended (step S210). Next, when determining that the utterance by the nearby person 42 has ended, the CPU 11a generates control information that makes the line constituting the display image 45 thinner (step S211).

### OTHERS

The case has been described above where three notification processings of the notification processing for a possibility of utterance before the utterance, the notification processing for a possibility of an end of utterance after the utterance is started, and the notification processing for an end of utterance after the utterance is started are performed.

It is not necessary to perform all of the three processings, and only one of the processings may be performed, or two of the processings may be performed.

The case has been described above where two notification processings of the notification processing for the possibility of an end of utterance and the notification processing when the utterance has actually ended are performed at the end of the utterance. However, only one of the two notification processings may be performed at the end of the utterance.

### Supplementary Note

(((1)))
An information processing system comprising a processor, wherein the processor acquires status information that is information related to a status of a nearby person who is a person located around a subject, and when the status specified by the status information acquired is a particular status, the processor generates control information that is used for controlling a device owned by the subject and causes the device to issue a notification indicating that there is a possibility of utterance by the nearby person.
(((2)))
The information processing system according to (((1))), wherein the processor acquires the status information of the nearby person based on a video in which the nearby person appears.
(((3)))
The information processing system according to (((1))) or (((2))), wherein, when there is no utterance by the nearby person, the processor generates control information that causes the device to issue a notification indicating that there is no utterance.
(((4)))
The information processing system according to any of (((1))) to (((3))), wherein the processor generates, as the control information that causes the device to issue the notification indicating that there is the possibility of utterance, control information that causes the device to issue a notification appealing to a vision of the subject.
((5)
The information processing system according to any of (((1)) to (((4))), wherein the processor generates, as the control information that causes the device to issue the notification indicating that there is the possibility of utterance, control information that causes a display unit of the device to display a display image that is an image displayed on the device and indicating that there is the possibility of utterance by the nearby person.
(6)
The information processing system according to (((5))), wherein, when there is no actual utterance by the nearby person after the processor generates the control information that causes the display image to be displayed on the display unit of the device, the processor generates control information that causes the display image displayed on the display unit to be erased.
(((7))
The information processing system according to (((5) or (6), wherein the processor generates, as the control information that causes the display image to be displayed on the display unit of the device, control information that causes the display image to be displayed in association with the nearby person.
(((8)))
The information processing system according to (((7))), wherein, when a plurality of the nearby persons is in the particular status, the processor generates, as the control information that causes the display image to be displayed in association with the nearby persons, control information that causes the display image to be displayed in association with each of the plurality of nearby persons.
(((9))
The information processing system according to any of (((5))) to (((8))), wherein, when the nearby person who has the possibility of utterance actually makes an utterance, utterance content that is content of the utterance is displayed on the display unit of the device, and the processor generates, as the control information that causes the display image to be displayed on the display unit of the device, control information that causes the display image to be displayed in association with a display section in which the utterance content is displayed in the display unit of the device.
(((10)))
The information processing system according to (((9))), wherein the processor generates, as the control information that causes the display image to be displayed in association with the display section, control information that causes the display image having a shape surrounding the display section to be displayed on the display unit.
(((11)))
The information processing system according to any of (((1))) to (10))), wherein, when the nearby person who is out of a range of a field of view of the subject who visually recognizes a front of the subject by the device is in the particular status, the processor generates control information that causes the display image that is an image indicating that there is a possibility of utterance by the nearby person who is out of the range of the field of view to be displayed on the display unit of the device.
(((12)))
The information processing system according to (((11))), wherein the processor generates, as the control information that causes the display image of the nearby person out of the range of the field of view to be displayed on the display unit of the device, control information that causes the display image to be displayed on a line connecting a position of the nearby person and a center of the display unit when the nearby person is projected onto a virtual plane along the display unit.
(((13))
The information processing system according to any of (((1))) to (((12))), wherein, in addition to pre-utterance status information that is the status information acquired before the nearby person actually utters, the processor further acquires mid-utterance status information that is information related to a status of the nearby person who actually has started an utterance, and when the status specified by the mid-utterance status information acquired is a particular status, the processor generates control information that is used for controlling the device and that causes the device to issue an end suggestion notification that is a notification indicating that there is a possibility of an end of utterance by the nearby person or generates control information that causes the device to issue an end notification that is a notification indicating that the utterance of the nearby person has ended.
(((14)))
The information processing system according to (((13))), wherein, when the status specified by the pre-utterance status information is the particular status, the processor generates control information that causes a display image determined in advance to be displayed on the display unit provided in the device, and generates, as the control information that causes the device to issue the end suggestion notification, control information that causes the display mode of the display image displayed on the display unit to be changed.
(((15)))
The information processing system according to (((14))), wherein the processor generates, as the control information that causes the device to issue the end notification, control information that causes the display mode of the display image whose display mode has been changed by the control information that causes the display mode of the display image to be changed to be further changed.
(((16)))
The information processing system according to any of (((13))) to (((15))), wherein the processor acquires the pre-utterance status information based on a video in which the nearby person appears, and acquires the mid-utterance status information based on voice information that is information related to voice of the nearby person.
(((17)))
An information processing system comprising a processor, wherein the processor acquires status information that is information related to a status of a nearby person who is located around a subject and is uttering, and when the status specified by the status information acquired is a particular status, the processor generates control information that is used for controlling a device owned by the subject and causes the device to issue a notification indicating that there is a possibility of an end of utterance by the nearby person, and/or generates control information that causes the device to issue a notification indicating that the utterance by the nearby person has ended.
(((18)))
The information processing system according to (((17))), wherein the processor acquires the status information of the nearby person based on voice information that is information related to voice of the nearby person.
(((19)
The information processing system according to (((17))) or (((18))), wherein the processor generates control information that changes a display image displayed on a display unit of the device as the control information that causes the device to issue a possibility suggestion notification that is the notification indicating that there is a possibility of an end of utterance.
(((20)))
The information processing system according to (((19))), wherein the processor generates, as the control information that causes the device to issue the possibility suggestion notification, control information that changes the display image that is displayed on the display unit and is displayed in association with a display section of utterance content of the nearby person.
(((21)))
The information processing system according to any of (((17))) to (((20))), wherein the processor generates control information that changes the display image displayed on the display unit of the device as control information that causes the device to issue an end notification that is a notification indicating that the utterance has ended.
(((22)))
The information processing system according to (((21))), wherein the processor generates, as the control information that causes the device to issue the end notification, control information that changes the display image that is displayed on the display unit and is displayed in association with a display section of utterance content of the nearby person.
(((23))
The information processing system according to (((20)) or (((22))), wherein the processor generates, as the control information that changes a corresponding display image that is the display image displayed in association with the display section of the utterance content, control information that changes at least one of a shape, a thickness, or a color of the corresponding display image displayed so as to surround the display section.
(((24)))
A non-transitory computer-readable recording medium storing a program for causing a computer to execute: an acquisition function of acquiring status information that is information related to a status of a nearby person who is a person located around a subject; and a generation function of generating control information that is used for controlling a device owned by the subject and causes the device to issue a notification indicating that there is a possibility of utterance by the nearby person when the status specified by the status information acquired by the acquisition function is a particular status.
(((25)))
A non-transitory computer-readable recording medium storing a program for causing a computer to execute: an acquisition function of acquiring status information that is information related to a status of a nearby person who is located around a subject and is uttering, and when the status specified by the status information acquired by the acquisition function is a particular status; and a generation function of generating control information that is used for controlling a device owned by the subject and causes the device to issue a notification indicating that there is a possibility of an end of utterance by the nearby person, and/or generates control information that causes the device to issue a notification indicating that the utterance by the nearby person has ended.

What is claimed is:

1. An information processing system comprising a processor,
wherein the processor acquires status information that is information related to a status of a nearby person who is a person located around a subject, and
when the status specified by the status information acquired is a particular status, the processor generates control information that is used for controlling a device owned by the subject and causes the device to issue a notification indicating that there is a possibility of utterance by the nearby person.

2. The information processing system according to claim 1, wherein the processor acquires the status information of the nearby person based on a video in which the nearby person appears.

3. The information processing system according to claim 1, wherein, when there is no utterance by the nearby person, the processor generates control information that causes the device to issue a notification indicating that there is no utterance.

4. The information processing system according to claim 1, wherein the processor generates, as the control information that causes the device to issue the notification indicating that there is the possibility of utterance, control information that causes the device to issue a notification appealing to a vision of the subject.

5. The information processing system according to claim 1, wherein the processor generates, as the control information that causes the device to issue the notification indicating that there is the possibility of utterance, control information that causes a display unit of the device to display a display image that is an image displayed on the device and indicating that there is the possibility of utterance by the nearby person.

6. The information processing system according to claim 5, wherein, when there is no actual utterance by the nearby person after the processor generates the control information that causes the display image to be displayed on the display unit of the device, the processor generates control information that causes the display image displayed on the display unit to be erased.

7. The information processing system according to claim 5, wherein the processor generates, as the control information that causes the display image to be displayed on the display unit of the device, control information that causes the display image to be displayed in association with the nearby person.

8. The information processing system according to claim 7, wherein, when a plurality of the nearby persons is in the particular status, the processor generates, as the control information that causes the display image to be displayed in association with the nearby persons, control information that causes the display image to be displayed in association with each of the plurality of nearby persons.

9. The information processing system according to claim 5, wherein, when the nearby person who has the possibility of utterance actually makes an utterance, utterance content that is content of the utterance is displayed on the display unit of the device, and the processor generates, as the control information that causes the display image to be displayed on the display unit of the device, control information that causes the display image to be displayed in association with a display section in which the utterance content is displayed in the display unit of the device.

10. The information processing system according to claim 9, wherein the processor generates, as the control information that causes the display image to be displayed in association with the display section, control information that causes the display image having a shape surrounding the display section to be displayed on the display unit.

11. The information processing system according to claim 1, wherein, when the nearby person who is out of a range of a field of view of the subject who visually recognizes a front of the subject by the device is in the particular status, the processor generates control information that causes the display image that is an image indicating that there is a possibility of utterance by the nearby person who is out of the range of the field of view to be displayed on the display unit of the device.

12. The information processing system according to claim 11, wherein the processor generates, as the control information that causes the display image of the nearby person out of the range of the field of view to be displayed on the display unit of the device, control information that causes the display image to be displayed on a line connecting a position of the nearby person and a center of the display unit when the nearby person is projected onto a virtual plane along the display unit.

13. The information processing system according to claim 1, wherein, in addition to pre-utterance status information that is the status information acquired before the nearby person actually utters, the processor further acquires mid-utterance status information that is information related to a status of the nearby person who actually has started an utterance, and when the status specified by the mid-utterance status information acquired is a particular status, the processor generates control information that is used for controlling the device and that causes the device to issue an end suggestion notification that is a notification indicating that there is a possibility of an end of utterance by the nearby person or generates control information that causes the device to issue an end notification that is a notification indicating that the utterance of the nearby person has ended.

14. The information processing system according to claim 13, wherein, when the status specified by the pre-utterance status information is the particular status, the processor generates control information that causes a display image determined in advance to be displayed on the display unit provided in the device, and generates, as the control information that causes the device to issue the end suggestion notification, control information that causes the display mode of the display image displayed on the display unit to be changed.

15. The information processing system according to claim 14, wherein the processor generates, as the control information that causes the device to issue the end notification, control information that causes the display mode of the display image whose display mode has been changed by the control information that causes the display mode of the display image to be changed to be further changed.

16. The information processing system according to claim 13, wherein the processor acquires the pre-utterance status information based on a video in which the nearby person appears, and acquires the mid-utterance status information based on voice information that is information related to voice of the nearby person.

17. An information processing system comprising a processor, wherein the processor acquires status information that is information related to a status of a nearby person who is located around a subject and is uttering, and when the status specified by the status information acquired is a particular status, the processor generates control information that is used for controlling a device owned by the subject and causes the device to issue a notification indicating that there is a possibility of an end of utterance by the nearby person, and/or generates control information that causes the device to issue a notification indicating that the utterance by the nearby person has ended.

18. The information processing system according to claim 17, wherein the processor acquires the status information of the nearby person based on voice information that is information related to voice of the nearby person.

19. The information processing system according to claim 17, wherein the processor generates control information that changes a display image displayed on a display unit of the device as the control information that causes the device to issue a possibility suggestion notification that is the notification indicating that there is a possibility of an end of utterance.

20. A non-transitory computer-readable recording medium storing a program for causing a computer to execute: an acquisition function of acquiring status information that is information related to a status of a nearby person who is a person located around a subject; and a generation function of generating control information that is used for controlling a device owned by the subject and causes the device to issue a notification indicating that there is a possibility of utterance by the nearby person when the status specified by the status information acquired by the acquisition function is a particular status.
